(19) United States
(12) Patent Application Publication
(10) Pub. No.: US 2010/0103810 A1
(43) Pub. Date: Apr. 29, 2010

(54) MODULATION CODING SCHEME SELECTION IN A WIRELESS COMMUNICATION SYSTEM

(75) Inventors: Michael N. Kloos, Belvidere, IL (US); Frederick W. Vook, Schaumburg, IL (US); Xiangyang Zhuang, Lake Zurich, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/256,528

(22) Filed: Oct. 23, 2008

(51) Int. Cl. H04J 9/00; H04K 1/10; H04W 4/00

(52) U.S. Cl. 370/204; 375/260; 455/127.2; 370/329

(57) ABSTRACT

A base station and method for selecting a modulation coding scheme (MCS) in an OFDM communication system, includes a first step 500 of estimating the channel response on each antenna based on the uplink feedback. A next step 502 includes calculating transmit weights from the uplink feedback. A next step 504 includes computing a beamformed Carrier-to-Interference plus Noise Ratio based on a broadcast Carrier-to-Interference plus Noise Ratio and the transmit weights and the channel response. A next step 506 includes choosing a best modulation coding scheme for a beamform allocation using the beamformed CINR. A best antenna gain and frequency band can also be chosen using the beamformed CINR.

### FIELD OF THE INVENTION

This invention relates to wireless communication systems, and in particular, to a mechanism for selecting a modulation coding scheme in a wireless communication system.

### BACKGROUND OF THE INVENTION

In mobile broadband cellular communication systems, there are several physical layer techniques that require a transmitter to be provided with knowledge of the channel response between the transmitter and a receiver. Transmission techniques that make use of the channel response between the transmitter and receiver are called closed-loop transmission techniques. One example of closed-loop transmission is the use of transmit precoding at the transmitter. An antenna array employing transmit precoding comprises of an array of multiple transmit antennas where the signals fed to each antenna are weighted in such a way as to control the characteristics of the transmitted signal energy according to some pre-defined optimization strategy, e.g. beamforming.

Generally, the transmitted antenna signals are weighted by applying weight vectors to multiple transmit antennas based on knowledge of the space-frequency channel response between each transmit antenna and each receive antenna. The transmitter uses these weight vectors and attempts to optimize the beamforming characteristics of the transmitted signal to be processed by the receiving device.

In general, there are different techniques for providing a transmitter with knowledge of the channel between each transmit antenna and each receive antenna. The methods described henceforth are applicable to any multiple-antenna equipped wireless transmitter. For the sake of clarity, this discussion is focused on the downlink of a cellular system using a Transmit Adaptive Array (TxAA) where the base station (BS) is the transmitter and a mobile station or subscriber station (SS) is the receiver.

One technique to control the transmit characteristics is based on uplink feedback messages from the SS, such as can be obtained from an uplink control channel or uplink Channel Quality Indicator (CQI) channel, where the SS measures the channel response from the broadcast dedicated pilot signals for demodulation between the BS antennas and the SS antennas, and transmits a feedback message back to the BS containing enough information that enables the BS to perform closed loop transmit preceding. This technique relies on digital signaling that includes codebook based quantization at the SS and encoding the precoding matrix index as a feedback message.

Another technique is based on the reciprocity of the RF channel response. An RF propagation channel may be treated as reciprocal (by virtue of TDD multipath channel reciprocity and antenna array transceiver calibration), which means the downlink RF channel matrix (where the matrix refers to the channel gains between each transmit and receive antenna) at a given time-frequency point is simply the matrix transpose of the uplink RF channel matrix at the same time-frequency point. In a TDD system, a downlink channel response can sometimes be derived from an uplink data transmission or an uplink control channel such as an uplink sounding channel. Along the same lines, in an FDD system some direction-of-arrival (DOA) based methods may be used to derive spatial properties of a downlink channel from uplink transmission.

However these techniques suffer from the same problem, the measurements made by the SS are done on broadcast pilot signals and not a beamformed signal, as will be used in data transmission. This leads to two problems. Firstly, measurements on broadcast signals will generally result in a lower Carrier-to-Interference plus Noise Ratio (CINR) measurements than would have been obtained from measurements on a beamformed signal. Secondly, this incorrect CINR will lead to selecting a suboptimal modulation coding scheme (MCS) for transmissions. In addition, the BS will not have a good estimate for what the MCS should be for the first TxAA allocation in a communication. Further, choosing a fixed gain for TxAA will not be optimal and must be chosen too conservatively.

Accordingly, what is needed is a technique to provide an improved system and technique for selecting a proper MCS and gain for a beamforming TxAA.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 shows a block diagram of a system, in accordance with the present invention;

FIG. 2 shows a block diagram of a first embodiment of the present invention;

FIG. 3 shows a block diagram of a second and a third embodiment of the present invention;

FIG. 4 shows a graphical representation uplink and downlink frame communication, in accordance with the present invention; and

FIG. 5 shows a flow chart illustrating a method, in accordance with the present invention.

Skilled artisans will appreciate that common but well-understood elements that are useful or necessary in a commercially feasible embodiment are typically not depicted or described in order to facilitate a less obstructed view of these various embodiments of the present invention.

### DESCRIPTION OF THE PREFERRED EMBODIMENTS

The present invention provides an improved system and technique for selecting a proper MCS and antenna gain for a beamforming TxAA. In particular, the present invention uses the BS's knowledge of the channel response in addition to the weights it will use on the beamformed data signals to accurately calculate the effective CINR the SS should see under the TxAA transmission. It is envisioned that the present invention is applicable to any communication system that uses transmit beamforming. As used herein, the present invention is described in terms of an IEEE 802.16 WiMAX communication system, but the present invention could be used equally well in other communication systems such as Long Term Evolution (LTE), for example.

Specifically, the present invention enables a base station to estimate the channel response on each antenna based on an uplink (UL) sounding waveform and/or any other UL transmission. The BS then calculates transmit (Tx) weights to be used for a beamformed transmission, and internally applies the Tx weights to the channel responses to derive the beamformed channel response that will be seen by the SS. The BS then translates the broadcast CINR into beamformed CINR since it knows the broadcast channel response, CINR, and the beamformed channel response. The BS can then use the beamformed CINR to choose the best MCS and antenna gain for the data allocation in Partially Used Subchannelization (PUSC) or band AMC subcarriers for the first (and possibly subsequent) beamformed allocation.

In a further embodiment, the present invention can select a frequency band to use for the beamformed transmissions. Specifically, the present invention enables a base station to estimate the channel response on each antenna based on the UL sounding waveform and/or any other UL transmission. The BS then calculates Tx weights to be used for the beamformed transmission, and internally applies the Tx weights to the channel responses to derive the beamformed channel response that will be seen by the SS. The BS then translates the broadcast CINR into beamformed CINR since it knows the broadcast channel response, CINR, and the beamformed channel response. The BS can then calculate the beamformed CINR on each band and choose the best bands for the SS at the moment for the data allocation in AMC (as well as best MCS and TxAA gain to use). This allows the use of optimal bands in every Adaptive Modulation and Coding (AMC) frame. In both of the above embodiments, the estimated CINR takes into account diversity techniques used on the broadcast portion of the frame (i.e. cyclic shift transmit diversity) in addition to expected beamformed gain based on channel response and transmit weights.

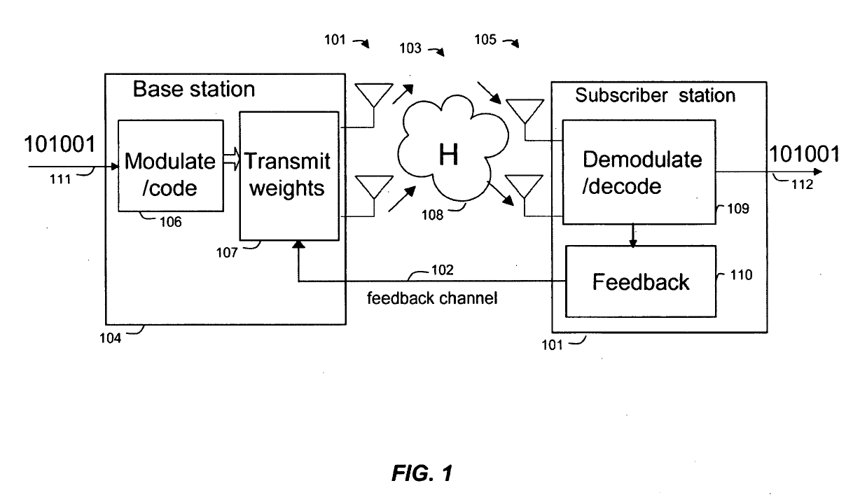

FIG. 1 shows a block diagram of communication system, in accordance with the present invention. The communication system can include a plurality of cells (only one represented) each having a base station (BS) 104 in communication with one or more subscriber station (one SS shown) 101. If closed loop transmission is to be performed on the downlink 103 to SS 101, the BS 104 can be referred to as a source communication unit, and the SS 101 can be referred to as a target communication unit. In the preferred embodiment of the present invention, communication system 100 utilizes an Orthogonal Frequency Division Multiplexed (OFDM) or multicarrier based architecture including Adaptive Modulation and Coding (AMC). The architecture may also include the use of spreading techniques such as multi-carrier CDMA (MC-CDMA), multi-carrier direct sequence CDMA (MC-DS-CDMA), Orthogonal Frequency and Code Division Multiplexing (OFCDM) with one or two dimensional spreading, or may be based on simpler time and/or frequency division multiplexing/multiple access techniques, or a combination of these various techniques. In addition, in alternate embodiments the communication system may utilize other cellular communication system protocols such as, but not limited to, TDMA, direct sequence CDMA (DS-CDMA), and the like.

The BS 104 includes a transmit adaptive antenna array (TxAA) 101 having a plurality of antenna elements (only two shown) operable to communicate a beamformed data stream to a SS 101 having one or more receive antennas 105 (e.g., a Multiple Input Multiple Output MIMO system). The input data-stream 111 is modulated and coded 106 and then multiplied by transmit weights 107 before being fed to the TxAA 101. Multiplying the input data-stream 111 by transmit weights 107, where the transmit weights are based on at least a partial channel response, is one example of tailoring a spatial characteristic of the transmission. The signals transmitted from the TxAA 101 propagate through a matrix channel 108 and are received by one or more of the receive antennas 105. The signals received on the one or more receive antennas 105 are demodulated and decoded 109 to produce the output data-symbol stream 112.

In accordance with the present invention, at least one SS 101 performs feedback measurements 110 based on the channel 108 and provides these measurements through an uplink feedback channel 102 to the BS 104. The feedback may include a sounding waveform, channel quality indicator, analog feedback (channel covariance coefficients, channel coefficients, or precoding matrix coefficients, or coefficients of an eigenvector of a covariance matrix), or codebook-based precoding matrix index feedback. In accordance with the present invention, the BS 104 then derives the transmit weights 107 accordingly, in order to improve the beamformed downlink reception by the SS, as will be detailed below. There are several varieties of TxAA; Eigen-beam forming (EBF), Max-Ratio Transmission (MRT), and Cluster beamforming (CBF), all of which will be described below in relation to the present invention. In the discussion below, superscript T represents the transpose of a matrix.

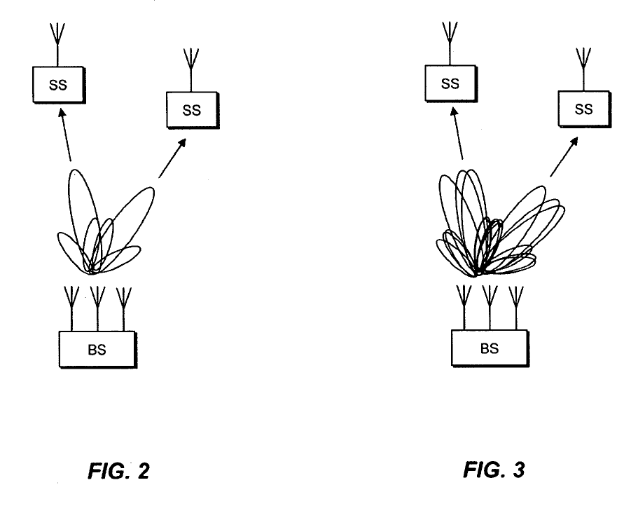

Referring to FIG. 2, in Eigen-beamforming (EBF), the downlink channel is measured by an SS which provides feedback on an UL CQI channel. One global weight vector is computed for the whole bandwidth. In an example of four Tx antennas and two Rx antennas, the measured 4×2 channel matrix for the k^{th} subcarrier is Hₖ. Let

$$R = \frac{1}{N} {\sum }_{k = 1}^{N} {H}_{k}^{T} {H}_{k}$$

where N is the total number of used subcarriers. In this case, the weight vector is the 4×1 eigenvector corresponding to the largest eigenvalue of R. This is accomplished by weighting each Tx signal to maximize the received signal to noise ratio (SNR). This effectively “steers” the transmit array such that it is “aimed” at the subscriber station that provided the feedback. In EBF, an average weight is computed and applied to all modulated subcarriers per user, and EBF can be used to support data transmission to several users simultaneously.

Referring to FIG. 3, in Maximal Ratio Transmission (MRT), the downlink channel is measured by an SS which provides feedback on an UL sounding channel. The weight vector is computed for each individual subcarrier. In the example of four Tx antennas and two Rx antennas, the measured 4×2 channel matrix for the k^{th} subcarrier is Hₖ. The weight vector for the k^{th} subcarrier is the 4×1 eigenvector corresponding to the largest eigenvalue of Hₖ^{T}Hₖ or the 4×1 singular vector corresponding to the largest singular value of Hₖ. This is accomplished by weighting each Tx signal to maximize the received signal to noise ratio (SNR). This effectively “steers” the transmit array such that it is “aimed” at the subscriber station that provided the sounding. In MRT, a separate weight is computed for each modulated subcarrier, and MRT can be used to support data transmission to several users simultaneously.

Referring again to FIG. 3, in Cluster Beamforming (CBF), the downlink channel is measured by an SS which provides feedback on an UL sounding channel. The Weight vector is computed for each individual cluster of subcarriers. The base station computes a cluster-wide EBF weight vector. The eigenvector corresponding to the largest eigenvalue of

$$R = \frac{1}{14} {\sum }_{k ∈ cluster}^{N} {H}_{k}^{T} {H}_{k}$$

where one cluster consists of fourteen contiguous subcarriers. This is accomplished by weighting each Tx signal to maximize the received signal to noise ratio (SNR). This effectively “steers” the transmit array such that it is “aimed” at the subscriber station that provided the sounding. In CBF, weights are averaged over clusters, and CBF can support several simultaneous users.

In all of the above scenarios, the present invention uses channel response feedback combined with transmit beamformed weights to estimate the beamformed CINR at the receiver. In particular, the BS calculates the beamformed CINR by averaging over the frequency and space allocation:

ΔCINR=Avg over allocation (10 log(|Hν_{TxAA}|²))−(10 log(|Hν_{broadcast}|²))

where ν_{broadcast} includes the cyclic shift transmit diversity response used on the broadcast transmission providing a known different signal per Tx antenna element. The BS then calculates the new beamformed CINR from the periodically reported physical CINR (PCINR) from the SS as:

new beamformed CINR=reported PCINR+ΔCINR

The BS can then use the estimated beamformed CINR to choose the best MCS and TxAA gain for the data allocation in PUSC and AMC, and can also use the estimated beamformed CINR to choose the best bands (subcarriers) for the SS at the moment in AMC. The best MCS can be chosen from a predetermined look-up table or algorithm.

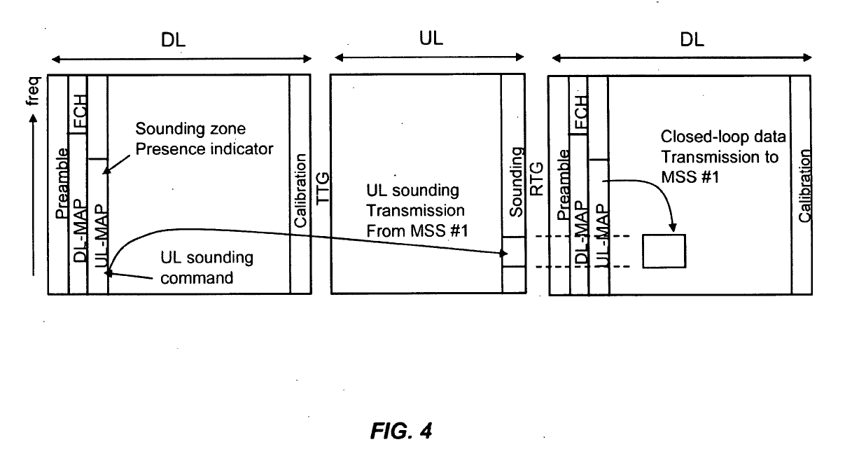

FIG. 4 illustrates the communication flow, in accordance with the present invention. In a first downlink (DL) frame, a sounding zone presence indicator is established in an UL-MAP. In the UL-AMP, the BS can include a command to a mobile SS (MSS #1 for example) to perform an UL sounding. In a next UL frame, MSS #1 provides the commanded UL sounding feedback to the BS at the same frequency to be used for DL data allocation for MSS #1. The BS uses the UL sounding feedback to estimate a DL beamformed CINR, as detailed above, and thereafter can determine an appropriate MCS (and possibly antenna gain and frequency band) to be used for its first closed-loop data transmission to MSS #1. This is communicated to MSS #1 in the next DL frame in the DL-MAP.

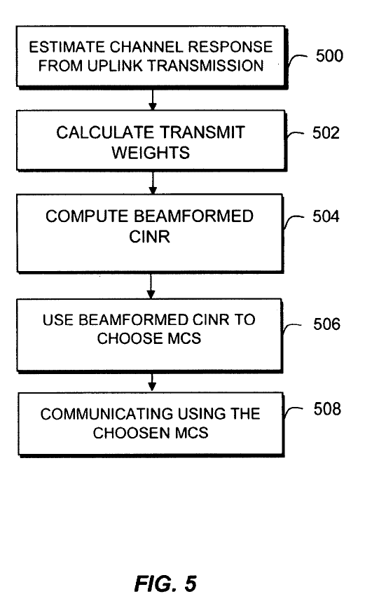

FIG. 5 shows a flowchart that illustrates a method for selecting a modulation coding scheme in an OFDM communication system, in accordance with the present invention. The method is operable under control of a base station, and in particular a processor in the base station.

A first step 500 includes a base station estimating a channel response on each antenna based on an UL transmission or feedback (e.g. sounding waveform, CQI, and/or any other UL transmission) from a subscriber station.

A next step 502 includes the BS calculating transmit (Tx) weights to be used for a beamformed transmission from the UL feedback.

A next step 504 includes the BS computing a beamformed Carrier-to-Interference plus Noise Ratio based on a broadcast Carrier-to-Interference plus Noise Ratio and the transmit weights and the channel response. This can include the BS internally applying the Tx weights to the channel response to derive the beamformed channel response that will be seen by the SS, and translating the broadcast CINR into beamformed CINR in response to the broadcast channel response, CINR, and the beamformed channel response. This step includes calculating

ΔCINR=Avg over allocation (10 log(|Hν_{TxAA}|²)−(10 log(|Hν_{broadcast}²))

where ν_{broadcast} includes the cyclic shift transmit diversity response used on the broadcast transmission, and calculating the new beamformed CINR from a reported physical CINR (PCINR) as:

new beamformed CINR=reported PCINR+ΔCINR+offset

where offset is a factor that takes into account effects not captured by the ΔCINR calculation above. For example, offset may include factors due to implementation losses. As another example, in some circumstances, the BS may only have partial knowledge of the channel H, in which case the offset term can be used to compensate for the incomplete knowledge of the channel H. Specifically, in some cases where the MSS has two antennas, H may only include the channel from one of the MSS antennas rather than both MSS antennas, in which case offset may simply be a 3 dB factor that attempts to account for the presence of the second MSS antenna, which was not included in the ΔCINR term. In some cases, offset may simply be set to zero (i.e., not included in this formula).

A next step 506 includes choosing the best MCS for the first (and possibly subsequent) beamform allocation to the subscriber station using the beamformed CINR. This step can also include choosing the best TxAA gain and best band for the SS at the moment for AMC.

A next step 508 includes communicating the MCS (and possibly band) to the subscriber station followed by communicating with the subscriber station using the chosen MCS.

It will be understood that the terms and expressions used herein have the ordinary meaning as is accorded to such terms and expressions by persons skilled in the field of the invention as set forth above except where specific meanings have otherwise been set forth herein.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for selecting a modulation coding scheme in a communication system, the method comprising the steps of:
estimating a channel response on each antenna based on an uplink transmission;
calculating transmit weights, to be used for a beamformed transmission, from the uplink transmission;
computing a beamformed Carrier-to-Interference plus Noise Ratio based on a broadcast Carrier-to-Interference plus Noise Ratio and the transmit weights and the channel response,
choosing a best modulation coding scheme for a beamforming allocation using the beamformed Carrier-to-Interference plus Noise Ratio; and
communicating using the chosen modulation coding scheme.

2. The method of claim 1, wherein the choosing step also includes choosing a best antenna gain using the beamformed Carrier-to-Interference plus Noise Ratio.

3. The method of claim 1, wherein the choosing step also includes choosing a best Adaptive Modulation and Coding band using the beamformed Carrier-to-Interference plus Noise Ratio.

4. The method of claim 1, wherein the uplink transmission is a from an uplink sounding channel.

5. The method of claim 1, wherein the uplink transmission is from a Channel Quality indicator channel.

6. The method of claim 1, wherein the computing step includes calculating
ΔCINR=Avg over allocation (10 log(|Hν_{TxAA}|²))−(10 log(|Hν_{broadcast}|²))
and calculating the new beamformed CINR based on a reported physical CINR (PCINR) and the ΔCINR.

7. The method of claim 6, wherein ν_{broadcast} includes the cyclic shift transmit diversity response used on the broadcast transmission.

8. The method of claim 1, wherein the choosing step includes choosing the best MCS for a first beamformed allocation to a subscriber station.

9. A method for selecting a modulation coding scheme in an OFDM communication system, the method comprising the steps of:
estimating the channel response on each antenna based on an uplink transmission from a subscriber station;
calculating transmit weights, to be used for a beamformed transmission to the subscriber station, from the uplink transmission;
computing a beamformed Carrier-to-Interference plus Noise Ratio based on a broadcast Carrier-to-Interference plus Noise Ratio and the transmit weights and the channel response,
choosing a best modulation coding scheme for a first beamform allocation to the subscriber station using the beamformed Carrier-to-Interference plus Noise Ratio; and
communicating with the subscriber station using the chosen modulation coding scheme.

10. The method of claim 9, wherein the choosing step also includes choosing a best Adaptive Modulation and Coding band using the beamformed Carrier-to-Interference plus Noise Ratio.

11. The method of claim 9, wherein the uplink transmission is a from an uplink sounding channel.

12. The method of claim 9, wherein the uplink transmission is from a Channel Quality indicator channel.

13. The method of claim 9, wherein the computing step includes calculating
ΔCINR=Avg over allocation (10 log(|Hν_{TxAA}|²))−(10 log(|Hν_{broadcast}|²))
wherein ν_{broadcast} includes the cyclic shift transmit diversity response used on the broadcast transmission, and calculating the new beamformed CINR based on the reported physical CINR (PCINR) and the ΔCINR.

14. The method of claim 9, wherein the choosing step includes choosing the best MCS for subsequent beamform allocations to a subscriber station.

15. A base station operable to select a modulation coding scheme for communication with a subscriber station in a communication system, the base station comprising a processor operable to estimate the channel response on each antenna based on an uplink transmission from the subscriber station, calculate transmit weights, to be used for a beamformed transmission to the subscriber station, from the uplink transmission, compute a beamformed channel response based on the transmit weights and the channel response, translate a broadcast Carrier-to-Interference plus Noise Ratio into a beamformed Carrier-to-Interference plus Noise Ratio, choose a best modulation coding scheme for a beamform allocation using the beamformed Carrier-to-Interference plus Noise Ratio, and communicate with the subscriber station using the chosen modulation coding scheme.
